(19) United States
(12) Patent Application Publication
(10) Pub. No.: US 2019/0038964 A1
(43) Pub. Date: Feb. 7, 2019

(54) PERSONALIZED CALIBRATION AND ADAPTION OF VR EXPERIENCE

(71) Applicants: Karthik Veeramani, Hillsboro, OR (US); Rajneesh Chowdhury, Portland, OR (US); Rajesh Poornachandran, Portland, OR (US); Curtis E. Jutzi, Lake Oswego, OR (US); Kunjal S. Parikh, Fremont, CA (US)

(72) Inventors: Karthik Veeramani, Hillsboro, OR (US); Rajneesh Chowdhury, Portland, OR (US); Rajesh Poornachandran, Portland, OR (US); Curtis E. Jutzi, Lake Oswego, OR (US); Kunjal S. Parikh, Fremont, CA (US)

(21) Appl. No.: 15/869,590

(22) Filed: Jan. 12, 2018

(51) Int. Cl. A63F 13/20; G06F 3/01; A63F 13/30

(52) U.S. Cl. CPC A63F 13/20; A63F 13/30; G06F 3/016; G06F 3/011

(57) ABSTRACT

In some embodiments, the disclosed subject matter involves automatically calibrating and adapting the configuration of a virtual reality (VR) session to accommodate user tolerances and experience preferences. In a test mode, a user is presented with content related to VR metrics. The user rates the content based on VR performance tolerance, which may be affected by user limitations, environmental characteristics, or personal preference. An initial set of calibration settings is generated based on the ratings, which may be used to configure the VR session for the user. Sensor data is collected during runtime to enable dynamic and automatic re-calibration of the settings. The VR rendering uses the calibration (e.g., re-calibration) settings to render VR content for the user.

### TECHNICAL FIELD

An embodiment of the present subject matter relates generally to virtual reality systems, and more specifically, but without limitation, to automatically calibrating and adapting the configuration of a virtual reality session to accommodate user tolerances and experience preferences.

### BACKGROUND

Virtual Reality (VR) systems are becoming more popular and more widely used. Various mechanisms exist for static pre-calibration of a virtual reality system for screen resolution or user preferences. Many VR and non-VR gaming consoles provide some initial calibration while setting up their solution. But existing VR solutions focus on factors that help tune the display and tracking, rather than comfort of the user. For instance, various VR gaming platforms determine whether the user has positioned the trackers correctly; whether there is any over scanning of the connected display; etc. A VR gaming platform may query the user to calibrate to a pre-set comfort rating of mild, medium or intense. Pre-set ratings such as these are an aggregation of the developers' or users' opinion on how uncomfortable the experience may make most users. Many VR gaming applications have a pre-defined rating of mild, intense, etc. that may be used to determine whether or not to download or purchase a game. However, these ratings are subjective, and what is mild for one user, may cause another user discomfort. Thus, the user must make a judgment call before engaging in the VR experience without full knowledge of whether the pre-set calibration will be tolerable or not. In systems that enable such calibration, dynamic adjustment and user feedback is not provided.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a flow diagram illustrating a method for dynamic VR calibration, according to an embodiment;

FIG. 2 is a block diagram illustrating a system for dynamic VR calibration, according to an embodiment;

FIG. 3 illustrates a system architecture of a Cloud VR Calibration Engine (CVRCE) architecture, according to an embodiment;

FIG. 4 is a chart illustrating different vision plots that bucket multiple users with varying visual acuity limitations; and

FIG. 5 is a block diagram illustrating an example of a machine upon which one or more embodiments may be implemented.

### DETAILED DESCRIPTION

In the following description, for purposes of explanation, various details are set forth in order to provide a thorough understanding of some example embodiments. It will be apparent, however, to one skilled in the art that the present subject matter may be practiced without these specific details, or with slight alterations.

An embodiment of the present subject matter is a system and method relating to automatic and dynamic calibration and adaption of a VR configuration to accommodate user tolerances and comfort. In at least one embodiment, sensor feedback may be used to identify whether a user is comfortable with a VR experience, and based on the readings, automatically adjust various configuration settings of the VR platform. Some feedback may be automatically collected by various sensors, and some feedback may require pro-active user entry.

In existing systems, a pre-set calibration may be performed or be customized for various specific or generic display devices or environments. Physical or virtual knobs may be present to allow the user to adjust 3D levels, brightness, contrast, audio volume. However, different users may be sensitive to different settings and require manual adjustments for each session and each VR application. For instance, one user may wear glasses and have difficulty with 3D glasses or HMD units because of the extra layer of optical glass. Another user may have cataracts and be sensitive to light, or require higher brightness or contrast. Another user might have high frequency loss and require an adjustment of audio frequency equalization. Various embodiments as described herein enable automatic and dynamic calibration of parameters of the VR experience, and enable generation of user-specific profiles that accommodate a user's tolerances and limitations. Profiles may include identification of devices and environmental characteristics so that the VR experience is automatically adjusted based on where the user is, and which device they are using for the experience.

Reference in the specification to “one embodiment” or “an embodiment” means that a particular feature, structure or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment, or to different or mutually exclusive embodiments. Features of various embodiments may be combined in other embodiments.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

Some people are highly prone to motion sickness, and VR use may exacerbate this tendency. Among other factors, the lag in the image catching up with head position may cause a sense of disorientation while in the virtual world. This type of disorientation may bother some people more than others. Some people are very sensitive to image quality, and VR amplifies this problem. A resolution that looks acceptable on a regular monitor may appear pixelated inside a head mounted display (HMD), because objects may appear much closer and immersive. Some people tolerate the lack of image quality better than others. These problems demonstrate that a VR configuration setup that works for one person may not be comfortable or tolerable for another. Existing approaches also do not have a capability to perform crowd-sourced analytics to improvise calibration in real-time for improved user experience (UX). For a VR platform or gaming environment or session to succeed, a wide variety of users must be comfortable using the VR environment. Embodiments described herein use an adaptive method to calibrate a user's tolerance using collected metrics, and adjust the VR experience dynamically at runtime, to accommodate the user.

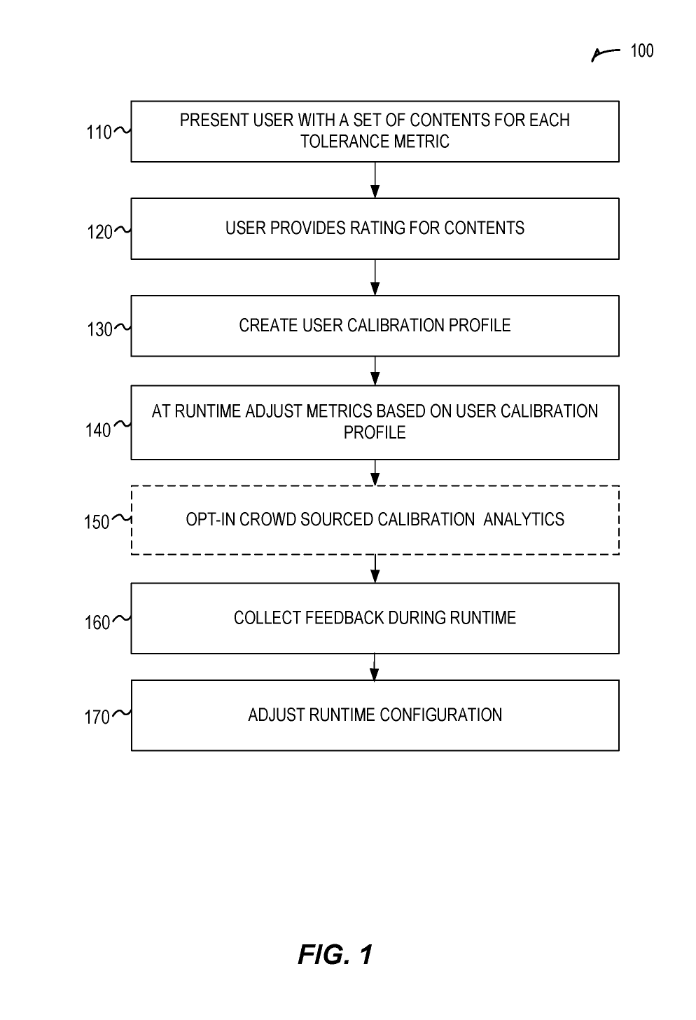

FIG. 1 is a flow diagram illustrating a method 100 for dynamic VR calibration, according to an embodiment. A user may perform a one-time calibration step when they setup their VR solution. In an embodiment, a VR system may test or query a user using one or more sets of content to identify the user's tolerance for various runtime metrics. A user is presented with the set of contents for each tolerance metric to be tested, in block 110. Each content within a set may vary in severity and range from most tolerable to least tolerable. The user views the content and rates their tolerance of that content experience, in block 120. For instance, a motion tolerance test may show content where objects move at varying speeds (e.g., slow to fast), and record the user's feedback regarding tolerability of the varying speeds presented in the content. Other content may be provided for other tolerance metrics to collect user rating.

In an example, a user is tested on, and provides ratings for, a set of predetermined metrics that affect VR experience. Some metrics that affect user tolerance may include motion blur, judder, image quality, but this is not an exhaustive list. As new experiences are created and more feedback is received additional content to measure other metrics may be included. User feedback may be as simple as good, acceptable, or unacceptable, or more detailed such as a scale of 1-10. In an example, calibration metrics tests may include user ratings for:
A set of static images ranging from best to worst resolution;
A set of moving objects going from smooth to blurry; or
A set of sequences where the user has to look around and the image catches up with the user gaze instantaneously, to progressively worse (induced latency).

The calibration results are stored as part of user profile. In an embodiment, a user interface may be provided to allow the user to override or disable the calibration parameters. Some of the tests may happen automatically without explicit user feedback, if possible. Auto-calibration may be performed by capturing user reaction through sensors in the environment, on the HMD or on wearable devices. Head or gaze tracking may be used to determine if the user may follow quickly moving objects. Squinting or facial expressions may indicate that an image is too blurry. Audio recognition of specific utterances may indicate pleasure or annoyance at the content. It will be understood that a variety of user reactions, expressions or emotions may be perceived with appropriate sensors and be correlated with specific content, metrics and devices used. After this calibration setup, a tolerance profile is created for the user, in block 130.

At runtime, the VR middleware may check the user's calibration profile, and attempt to adjust metrics to maximize the user's comfort level, in block 140. In an embodiment an image resolution may be used as another calibration metric. For instance, a user who is sensitive to image resolution, but more tolerant of judder, may be presented a higher quality image during runtime, at the expense of drop in frame rate. It will be understood that a variety of tolerance metrics may be used for calibration.

When the user launches a VR experience, a VR subsystem loads the user's tolerance profile and notes the metrics that negatively affect this user the most, and also note the metric this user is able to tolerate the most. The user may also provide explicit rating to a user interface (UI) after the experience about their feelings, to provide feedback. Embodiments continuously profile the user movement for the specific game or VR experience along with other metrics such as any frame drops (e.g., due to delayed rendering) to build heuristics to determine a correlation between the rendering and frame drops. These heuristics may be quantified into different characteristics buckets, for instance, for characteristics such as: resolution, audio, video quality, frame drops, etc.

In an embodiment, opt-in crowd-sourced calibration analytics may be used that may track the user response or comfort zone across variety of VR applications, devices, etc., along with explicit/implicit user feedback to perform improved calibration in real-time, in block 150. A user may voluntarily upload private profile information to a public cloud server for use with the crowd-sourced analytics. In an embodiment, the user's personal data may be removed or anonymized, and only demographic and device information sent for use with the calibration analytics. In another embodiment, the user may choose to allow personal data to be used in the analysis, perhaps for remuneration, or free game play, etc.

Embodiments as described herein improve on a single pre-runtime calibration, if any, by using both initial calibration and dynamic recalibration based on user feedback, user responsiveness to content rendered, rendering statistics (e.g. frame drops), etc. In an embodiment, Iris scans and association for personalized content delivery based on user tolerance level may be used. The user may also provide feedback during runtime using a hardware, physical or virtual knob, or control, with exposure to VR software, in block 160, so that gaming framework such as the Unity® software engine available from Unity Technologies, may expose appropriate application program interfaces (APIs) that may be customized by applications at runtime to meet a user's comfort calibration needs. Framework API feedback to application developers may be provided to improvise or adapt applications for specific customer base calibration.

In an embodiment, feedback may include:
explicit feedback by the user;
behavioral feedback;
crowd-sourced feedback from other peer users;
emotional feedback; or
environmental feedback.
   Explicit feedback includes the testing, as described above, or entering other feedback during runtime. Behavioral feedback may be identified with sensors worn by the user, or in proximity to the user. User behavior—such as head jerk, squinting, rapid or slow movements, gestures, back slump, moaning, whining, etc.—may be captured with motion sensors, microphone arrays, cameras, or other sensors to identify a user's behavior. Gesture recognition may be identified, also, to trigger an explicit feedback session. A user's emotion may be sensed using similar and other sensors, including thermal skin temperature monitors, heart rate monitors, etc. Emotions such as surprise, distress, unhappiness with difficulty seeing or hearing, and even nausea may be identified based on a user's facial expression, body language, or physical state. Environmental sensors may be available to measure the ambiance in the room, or identify a user's location, audio interference, lighting glare, etc. A measure of importance, or weight may be applied to each of the feedback types, for a re-calibration analysis. Calibrations may be adjusted at runtime, based on continuous automatic or explicit user feedback, in block 170.

In an embodiment, weights applied to the various feedback may be changed based on environmental or other conditions. For example, if a user is operating the VR experience at home, in a gaming room, many environmental and behavioral sensors may be present to provide feedback. The user's behavioral and emotional condition may the weighted more heavily. If the user is in a public, crowded, noisy area, audio calibration may take precedence over emotional calibration, for instance, because fewer cameras and other sensors may be available to capture these characteristics.

A crowd-sourced cloud calibration analytics server may perform crowd-sourced input from participating (opt-in) devices or users along with calibration info, thereby enabling rating or calibrating to be parametrized or personalized per user or device. In an embodiment, crowd-sourced profiles may be abundant, and a user may find one that is at an appropriate comfort level. A pre-defined or template calibration profile may be useful when the user is experiencing the VR in an area where feedback possibilities are at a minimum, or the user does not want to spend the time going through the testing steps.

Motion sickness not related to the motion/image quality may be quantified by the framework (especially with above crowd sourcing it would help in better convergence and UX). For instance, the ambiance or environment lighting may have an effect on the user's nausea. If glare is present and the user needs to continually engage in a head tilt to see the display, the movement of fluid in the inner ear may cause nausea. This type of feedback and adjustment is not possible in existing systems because, for instance, glare is not a parameter able to be adjusted.

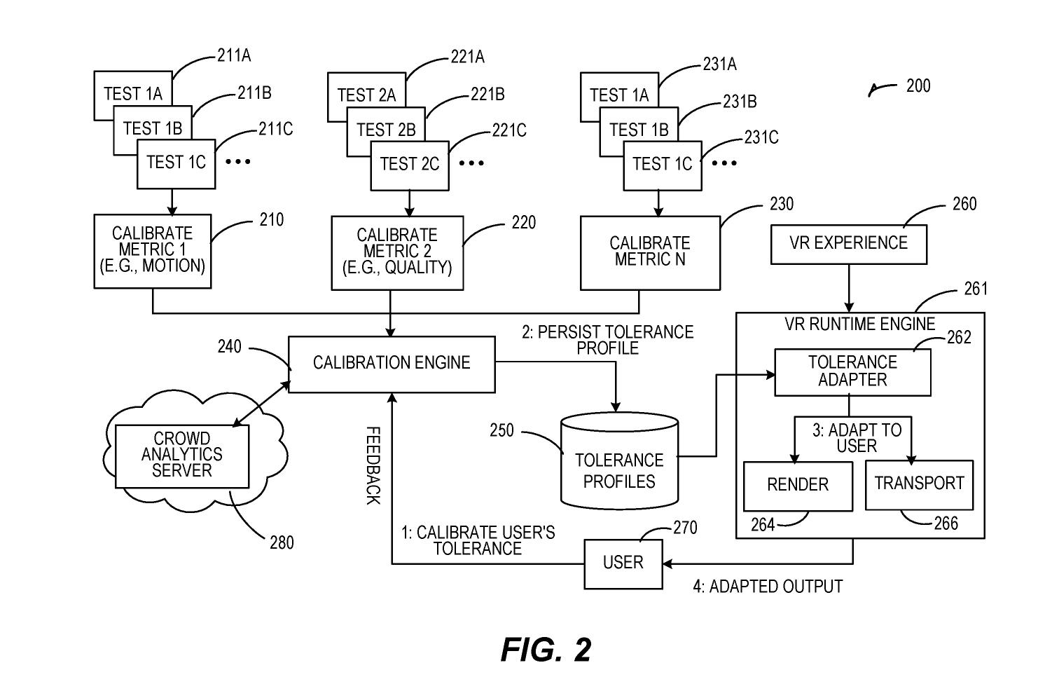

FIG. 2 is a block diagram illustrating a system 200 for dynamic VR calibration, according to an embodiment. In an embodiment a calibration engine 240 may include logic 210, 220, and 230 to be used to identify user tolerances. In an example, for a specific VR experience, various metrics may be identified for adjustment to improve the user experience (UX). In an example, metrics that may affect the UX include motion and image quality. Test content 211A-C may be provided to the user for rating on tolerance of motion, e.g., slow, medium or fast motion, by motion calibration logic 210. Test content 221A-C may be provided to the user for rating on tolerance of image quality/resolution, e.g., low resolution, medium resolution, high definition (HD) resolution, etc., by quality calibration logic 220. Other metrics may be tested, based on the VR experience, such as audio, thermal, physical motion, lighting conditions, etc. Test content 231A-C may be provided to the user for rating on tolerance of metric N by a metric N calibration logic 230. It will be understood that while calibration logic for two specific and one generic metric is shown, more or fewer metrics may be calibrated for the user.

Calibration engine 240 may collect the user ratings from the calibration logic 210, 220, 230 and generate user tolerance profiles for storage 250. The VR experience 260 may be adapted to a stored user tolerance profile. In an embodiment, a runtime engine 261 for the VR includes a tolerance adapter 262, a rendering engine 264, and a transport engine 266. The tolerance adapter 262 retrieves the user's tolerance profile from datastore 250 and configures the VR experience 260 to the user. For example, if the user cannot tolerate fast motion without getting queasy, the tolerance adapter may configure a movement parameter to a slower speed. If the user cannot tolerate low resolution images, HD frames may be chosen instead of SD. The tolerance adapter may configure a rendering engine 264 to render the images as configured for the user, e.g., slower motion and HD resolution. The rendering engine 264 constructs the graphics, frames, 3D images, etc., based on the tolerance configurations or parameters. The frames may be temporarily stored in a buffer, memory storage, or passed directly to the transport component 266. Transport component 266 sends the constructed or rendered frames to the appropriate display, such as an HMD, mobile device display, etc. The transport component 266 may send the frames by a wired or wireless means, as appropriate for the user's device architecture.

The pre-calibration customization may not be perfectly optimized, or accommodate actual VR experience scenarios and images. Thus, in an embodiment, the user tolerance profiles may be automatically adjusted during runtime. In an example, the user 270 interacts with the VR experience 260. Sensors may include, but are not limited to: motion, accelerometer, image capture, audio capture, touch, haptic, thermal, or heat sensing, and barometric, etc. Various sensors may capture metrics corresponding to the user's reactions, behaviors, gestures, movements, utterances, and explicit feedback. Sensors may be worn by the user, integrated in with an HMD, mounted in the environment, or coupled to another wearable or mobile device. Information, or feedback, regarding the user's reaction to the VR experience may be analyzed by calibration engine 240, and used to dynamically adapt and calibrate the user's tolerance profile. In an example, a user may have ranked quickly moving objects as tolerable. In practice, during the VR experience, the user's gaze may wander from the moving image, for instance, when the user's eyes cannot easily follow and locate the object. The user's expression might indicate nausea when the image is blurry (e.g., low quality), or jittery, or changing planes too quickly, etc. In this case, calibration may be performed to reduce the nausea inducing characteristics of the VR. In an embodiment, feedback is continually provided to the calibration engine, so the user tolerance profile may continue to change until the user appears to be more comfortable with the VR experience. Analysis of the feedback may be interrupt driven, or occur only at specific pre-defined intervals. For example, in an embodiment, the user may be provided a physical or virtual button or switch to trigger a recalibration, Recalibration may also occur at pre-specified intervals, e.g., every n minutes, or at the beginning of a new experience level of the VR experience, or similar.

In an embodiment, crowd-sourced cloud calibration analytics may be used to improve a user's initial or recalibrated tolerance profile. An analytics server 280 may perform crowd-sourced input from participating devices or users (e.g., users that have opted-in) along with calibration information. For instance, in an example, content 211A may have an average rating of SLOW by other users using device A, but have an average rating of FAST for device B. These average ratings may be weighted with the user's selections during calibration to generate a weighted calibration by the calibration engine in generation of the user's tolerance profile. For instance, Motion sickness not related to the motion or image quality may be quantified by the framework (especially with above crowd-sourcing to help in better convergence and UX). In an example embodiment, Analytics server 280 may provide a Cloud Dash Board User Interface (not shown) that may allow users to securely log-in, configure, setup policies to manage the calibration settings across one or more devices (e.g. work vs. personal). This may help the CVRCE to perform appropriate recommendation based on configured policies across one or more user devices.

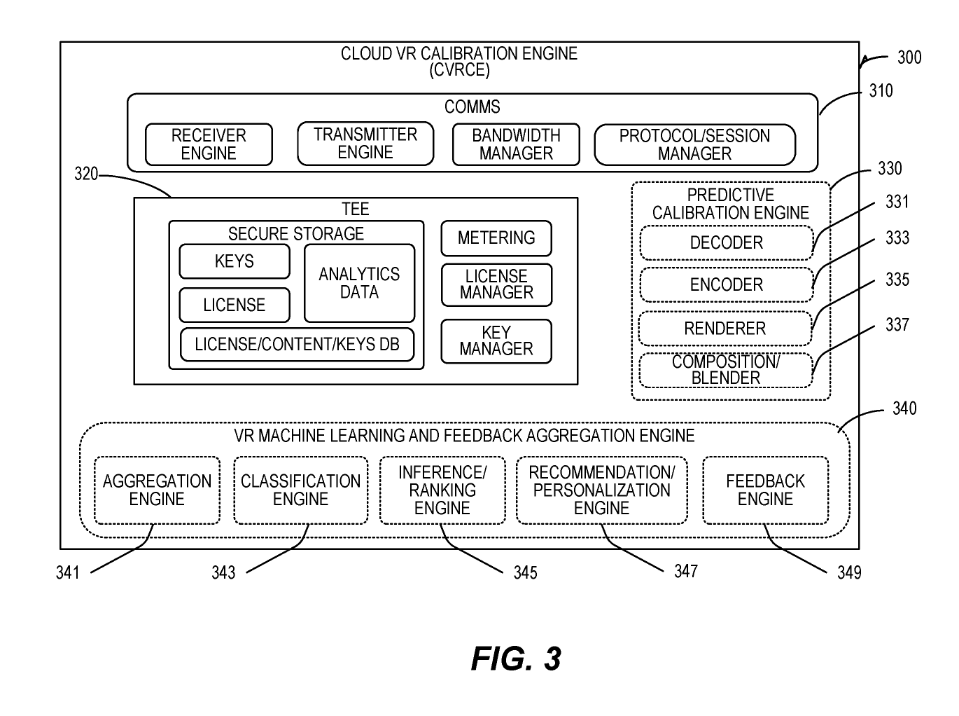

FIG. 3 illustrates a system architecture of a cloud VR calibration engine (CVRCE) architecture 300, according to an embodiment. In an embodiment, the CVRCE 300 coordinates receipt of sensory input and adapting calibration for specific client devices or users dynamically, and in real time. CVRCE 300 may have a feedback channel to optimize machine learning convergence. In an embodiment, CVRCE 300 includes the following sub-systems, similar to other VR systems: Communication Modules or logic (COMMS) 310; and Trusted Execution Environment (TEE) 320. Embodiments described herein may also include a VR Machine Learning and Feedback Aggregation Engine 340; and a Predictive Calibration Engine 330. As illustrated, components shown with solid lines are typically found in existing systems. Components shown with broken lines (330, 340) provide the dynamic, real-time calibration as described herein.

Communication modules 310 may assist in protocol and session management with other participating entities, and include transmitter and receiver engines. COMMS 310 may include bandwidth and session managers, as in existing systems.

Trusted Execution Environment (TEE) 320 may include a tamper resistant isolated execution environment with dedicated storage to process high value content, user privacy or sensitive information, keys, license and associated metering analytics. It will be understood that a variety of TEE solutions may be used to provide appropriate privacy and security to users and their VR sessions.

In an embodiment, the VR Machine Learning and Feedback Aggregation Engine 340 provides the capability to aggregate real-time feedback from VR clients (sensory, user configuration, tuning inputs, etc.). The feedback aggregation engine 340 may include an aggregation engine 341, classification engine 343, inference or ranking engine 345 and a recommendation or personalization engine 347, also referred to as a recommendation engine 347, for simplicity.

A VR machine learning and feedback aggregation engine 341 may aggregate data from a variety of input sources. Input sources, for example may include, but without limitation, Internet of Things (IOT) sensing devices, audio or video capture devices, accelerometers, motion detectors, thermal, environmental sensors, and sensors coupled to a VR headset or wearable device. This aggregation engine 341 may be communicatively coupled with a variety of input sources via an IP network to aggregate data. Data aggregation policies (e.g. sampling interval) may be user or system administrator configurable.

A classification engine 343 may perform rule based data classification. Raw data from a variety of input sources may be classified accordingly with an appropriately trained data set for accurate inference. For example, audio data classification criteria may be orthogonal to image classification criteria. In an embodiment, environmental data and behavioral data may be classified as such so that inferences may be made as to the quality and character of the sensed data, and for weighting of importance to calibrations. A trained machine learning model may be used to assist in classification of the sensor data.

An inference and ranking engine 345 may identify characteristics in the aggregated and classified data, and perform rule based inference by correlating the data across various sources. Inference engine 345 identifies such scenarios using the raw data, rules, user opt-in preferences, etc., (e.g., multi-sensor assertion based). Inference engine 345 may use rule based logic to resolve any conflicts of sensor assertion. In an example scenario, a lowest common denominator may be taken or an assertion score may be assigned to sensors based on their confidence of assertions in the past. The inference engine may help identify location of the user, such as indoors, outdoors, home, public place, etc. Ranking and influence of cues in sensor reading may infer the location. Location may be important to calibration. For instance, if a user is indoors in a darker location, the possibility of glare is lower than if outside in daylight. Thus, inference in environment may help rank various calibration settings for the user's VR session. If no data is available except for the HMD, it may be inferred that the user is not collocated with other sensors, and data from the HMD may be ranked higher in calibration, by dynamically changing the weights in calibration calculations.

A recommendation engine 347 may provide notifications for personalization as an appropriate recommendation based on learned user patterns and personalized predictive calibration to be delivered.

A feedback engine 349 may be use to perform adaptive feedback received from the variety of input sources, as discussed above. The system 300 may adapt its machine learning framework, inference and recommendation system based on the feedback. Users may opt-in to provide their preferences via a cloud dashboard for appropriate content calibration adaption across one or more devices, and to allow their preferences to be crowd sourced for other users and devices.

A predictive calibration content engine 330 may provide appropriate predictive calibration recommendations, as received from the machine learning engine 340. Additionally, this predictive calibration engine sub-system 330 may determine the dynamic latency incurred due to network, client rendering capabilities, etc., and perform appropriate content generation or scene updates to the client on an on-demand basis. The predictive calibration engine may include a decoder 331, encode 333, renderer 335, and compositor-blender 337.

In an example VR system, content is typically provided bi-directionally between a user and a VR server. Because of privacy, security, bandwidth and other transmission constraints, the content may be compressed and also possibly encrypted before transmission. A decoder 331 serves to decompress, decrypt or unpack the received content for use. Similarly, an encoder 333 serves to compress, encrypt or package the content before transmission.

During runtime, content (e.g., audio, graphics, 3D video, etc.) needs to be constructed and rendered for use for the appropriate display device(s). Renderer 335 may render and present the content to the user. During rendering, adjustments may be made based on the user tolerance profile and characteristics of the content to be presented. The adjustments may be made in the VR pipeline to improve the metric that affects the user most negatively, at the cost of affecting the other metrics to which the user is less sensitive. In an example, if a user is sensitive to judder, but not to quality, the rendering pipeline 335 may use higher frame rate by dropping the resolution. The render pipeline 335 may also choose to enable a more sophisticated re-projection algorithm to compensate user's head movement to make the motion smoother. In another example, if a user is more tolerant of judder but prefers better resolution, the renderer pipeline 335 may adjust accordingly to render at higher resolution at the cost of added latency.

In some scenarios, more than one content is to be blended or combined to construct a single view or rendering for the user. In an example, audio foreground and background noises may need to be blended for a stereo presentation to the user. In another VR experience, foreground 3D animation is to be overlaid onto a standard backdrop animation scene. In another example, audio and video are provided separately or on separate channels and must be synchronized and combined. Composition/blender engine 337 serves to combine or blend contents for display and rendering to the user. In an example, a user may have only a single speaker in a VR headset or have impaired hearing on one ear. Calibrations may be used by the renderer 335 or composition/blender 337 to construct all audio to one channel for the user. Existing systems might continue to present stereo audio on multiple channels and dialog or instructional audio could be completely inaudible to a hearing impaired user, or user with a monaural device.

An embodiment may help a user determine if a content in the VR APP store (e.g., VR content available for download or purchase) will be suitable to them. For instance, a VR application or content may have a rating such as mild, medium, or intense. The CVRCE 300 may retrieve this rating before download and cross check the public rating against the user's tolerance profile. In an embodiment, the recommendation engine 347 may recommend to the user that the content intended for download may not suit their tolerance levels.

Automatic calibration may be performed, as discussed above. In an embodiment, an iris scanner built into the HMD may help infer the vision limitations of a user, enabling the VR system 300 to modulate resolution accordingly. Iris scans may be leveraged to uniquely identify calibration profile settings associated with specific users. This may enable some embodiments to augment existing VR vision rectification solutions to benefit and associate appropriate calibration settings with dynamic feedback personalized per user.

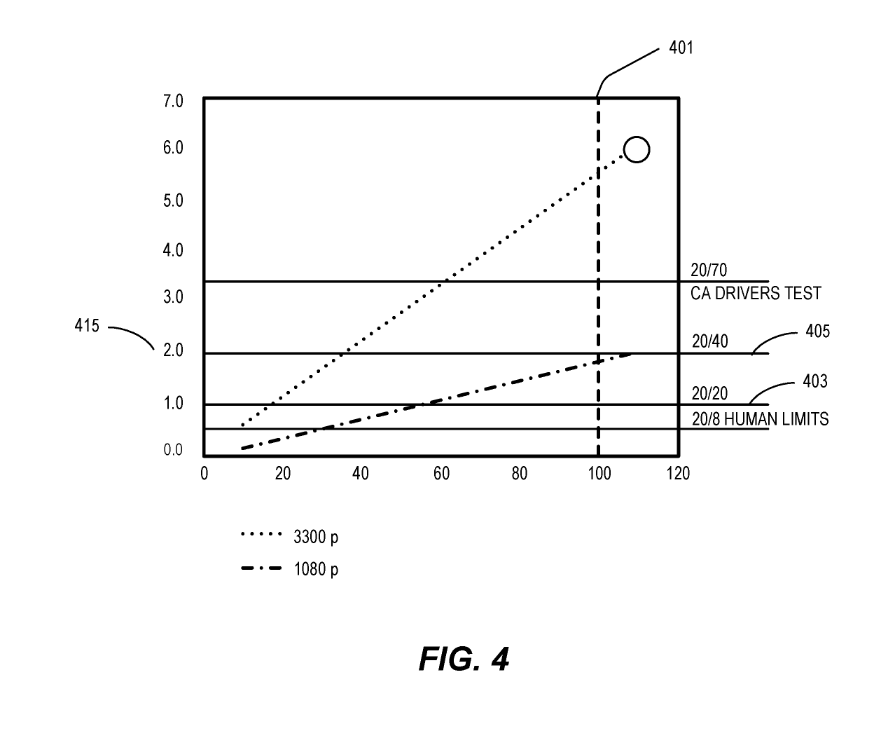

Another example of auto calibration is to modulate the resolution. Thus, the data rate and power requirements/utilization may be inferred based on human vision limitations. FIG. 4 is a chart illustrating different vision plots that bucket multiple users who may have 20/8 vision (e.g., young children) to 20/70 vision (e.g., older adults). The chart shows angular resolution (e.g. arc-minute) vs. field of view (FoV) for two different resolution lines (3300p and 1080p). As inferred from the vertical, black dashed line 401, eye characteristic may be sensed to identify what bucket of vision a particular user falls into (e.g. 20/20 (403) vs. 20/40 (405)), which may help modulate the resolution to render on the screen. For example, a 100 degree FoV 401 will not discern pixels that are below 2 Arc-Minutes 415 (e.g., 20/40 vision), and resolutions may be rendered (lower) to save on data rate, power, etc. without any visual artifacts (e.g. screen door effect). The eye vision characteristics may be easily mapped using an iris scanner or by portraying a Snellen chart and eliciting feedback. A graph of limits to human vision is shown as an example for meaningful personal calibration. It will be understood that a graph for aural tolerances, movement tolerances, or other characteristics may be applied to find a calibration “sweet spot” for rendering optimal content that correspond to a user's specific limitations.

In an embodiment, a user may engage in a multi-user VR game with one or more other users. A VR application may identify that one user has a specific advantage over other users, perhaps due to better hardware, display refresh rate, processor speed, etc. It may be that the users desire to even the playing field and mitigate the advantage(s) one user may have over the others. The calibration settings of the user with the hardware advantage may be throttled down within the user's tolerance settings, to make the game more fair for all users. In an embodiment, this recalibration is automatic. In an embodiment, all users in a game session may opt-in to allow for the re-calibration, and if any one user does not opt-in, the re-calibration may be prohibited. In an embodiment, only hardware or device advantages may be accounted for with re-calibration of settings, and the re-calibration will be within the limits that the user has rated as acceptable tolerance. In an embodiment, analysis of game play and re-calibration may be triggered at a user's request, a game administrator's request, a third party request, or occur automatically.

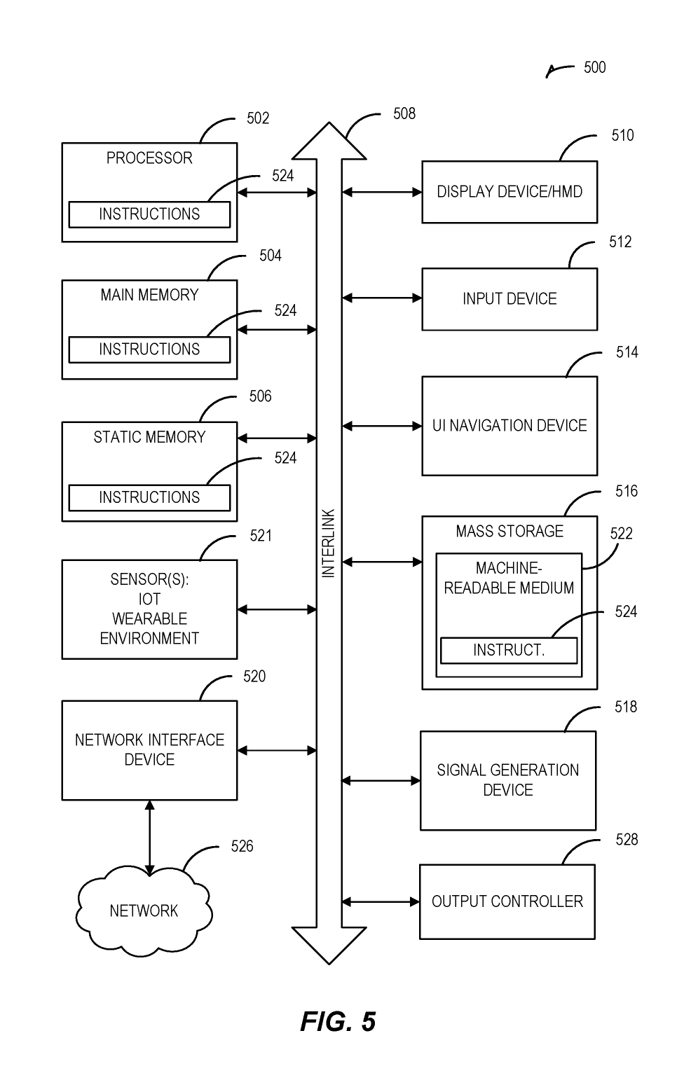

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a coupled to or include a virtual reality display, such as in a head mounted display unit. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or audio or video capture devices, or other sensor. In an embodiment, sensors 521 may include IoT connected sensors, wearable sensors, environmental sensors, etc. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

### ADDITIONAL NOTES AND EXAMPLES

Examples may include subject matter such as a method, means for performing acts of the method, at least one machine-readable medium including instructions that, when performed by a machine cause the machine to performs acts of the method, or of an apparatus or system for personalized calibration of settings for a VR experience, according to embodiments and examples described herein.

Example 1 is a system for automatic and dynamic virtual reality session calibration, comprising: a server compute node comprising a processor coupled to a memory, the processor to execute a virtual reality application according to a set of calibration parameters; a feedback and aggregation engine coupled to the processor to: receive a plurality of sensor metrics from at least one sensor, the sensor metrics associated with a user to provide aggregated metrics; classify each of the aggregated metrics according to a set of characteristics; generate a set of inferences regarding user tolerances corresponding to the classified metrics and rank each inference in the set of inferences based on the user tolerances; and generate a set of calibration parameters personalized to the user, based on the ranked set of inferences; and a predictive calibration engine to render the virtual reality content according to the personalized calibration settings for the user.

In Example 2, the subject matter of Example 1 includes, wherein the personalized calibration settings are automatically and dynamically re-calibrated during runtime.

In Example 3, the subject matter of Examples 1-2 includes, a trusted execution environment coupled to the server compute node to securely communicate with the user.

In Example 4, the subject matter of Examples 1-3 includes, a user interface coupled to the server compute node to provide a cloud dashboard allowing the user to view the calibration parameters personalized to the user, and manually calibrate the calibration parameters for use by one or more devices.

In Example 5, the subject matter of Example 4 includes, wherein the predicative calibration engine is further to: infer an optimal calibration setting for a user application based on personalized calibration settings for a plurality of user calibration settings accessible by the cloud dashboard, wherein each of the personalized calibration settings is associated with a user, a device and a user application.

In Example 6, the subject matter of Examples 1-5 includes, a training calibration engine to: provide test content to the user; receive responses from the user regarding tolerance of the content; generate an initial set of calibration settings for the user; and store the initial set of calibration settings in a tolerance profile database accessible to the feedback and aggregation engine to implement dynamic re-calibration of the calibration settings during runtime responsive to the sensor metrics.

In Example 7, the subject matter of Examples 1-6 includes, wherein the sensors collect the sensor metrics associated with at least one of explicit user feedback data, behavioral feedback data, emotional feedback data or environmental feedback data.

In Example 8, the subject matter of Example 7 includes, wherein the sensor metrics associated with the environmental feedback data are used to modify importance ranking of an inference.

In Example 9, the subject matter of Examples 1-8 includes, a user interface to enable the user to override a calibration setting with one of a physical or virtual control, and wherein responsive to a calibration setting being overridden by the user, the feedback and aggregation engine automatically adjusting an importance ranking of an inference based on the user input.

In Example 10, the subject matter of Examples 1-9 includes, wherein the calibration settings are related to at least one of visual, aural, movement, tactile, or haptic characteristics of the virtual reality application as presented to the user.

In Example 11, the subject matter of Example 10 includes, wherein the virtual reality application provides a multi-user experience, and wherein calibration settings for a second user are automatically adjusted based on calibration settings of the first user to prevent unfair advantages based on superior device rendering or tolerance levels of the second user, and where the adjusted calibration settings are within a tolerance level for the second user.

Example 12 is a method for generating adaptable personalized calibration settings for a virtual reality experience application, comprising: presenting a user with a content related to a metric associated with virtual reality rendering or playback; receiving a rating for the content from the user, wherein the rating corresponds to a tolerance of the user; correlating the rating of the content and tolerance of the user with virtual reality characteristics including frame rate, judder, motion, blur, image resolution, brightness, contrast, wherein a correlation between and among components of the virtual reality experience is derived from a trained machine learning model; generating a personalized calibration setting for configuring the virtual reality experience application; and storing the personalized calibration setting in a tolerance profiles database accessible to a rendering engine of the virtual reality experience application.

In Example 13, the subject matter of Example 12 includes, repeating the presenting, the receiving and the correlating for at least one additional content.

In Example 14, the subject matter of Example 13 includes, dynamically re-calibrating the personalized calibration settings during runtime of the virtual reality experience, by a feedback engine, the feedback engine using at least one of explicit user feedback data, behavioral feedback data, emotional feedback data or environmental feedback data inferred from metrics received from a plurality of sensors.

In Example 15, the subject matter of Example 14 includes, wherein the plurality of sensors reside on at least one of a wearable device, a head mounted display, an object in the environmental, or a mobile device.

In Example 16, the subject matter of Examples 12-15 includes, responsive to an indication that the user wants to override a calibration setting via user input, automatically adjusting an importance ranking of an inference based on the user input, wherein the ranking of the inference adjusts the correlations between and among components, and wherein the override is used as training input to the trained machine learning model.

Example 17 is at least one machine readable storage medium having instructions stored thereon, the instructions when executed on a machine cause the machine to: present a user with a content related to a metric associated with virtual reality rendering or playback; receive a rating for the content from the user, wherein the rating corresponds to a tolerance of the user; correlate the rating of the content and tolerance of the user with virtual reality characteristics including frame rate, judder, motion, blur, image resolution, brightness, contrast, wherein a correlation between and among components of the virtual reality experience is derived from a trained machine learning model; generate a personalized calibration setting for configuring the virtual reality experience application; and store the personalized calibration setting in a tolerance profiles database accessible to a rendering engine of the virtual reality experience application.

In Example 18, the subject matter of Example 17 includes, instructions to: repeat the presenting, the receiving and the correlating for at least one additional content.

In Example 19, the subject matter of Example 18 includes, instructions to: dynamically re-calibrate the personalized calibration settings during runtime of the virtual reality experience, by a feedback engine, the feedback engine using at least one of explicit user feedback data, behavioral feedback data, emotional feedback data or environmental feedback data inferred from metrics received from a plurality of sensors.

In Example 20, the subject matter of Example 19 includes, wherein the plurality of sensors reside on at least one of a wearable device, a head mounted display, an object in the environmental, or a mobile device.

In Example 21, the subject matter of Examples 17-20 includes, instructions to: responsive to an indication that the user wants to override a calibration setting via user input, automatically adjust an importance ranking of an inference based on the user input, wherein the ranking of the inference adjusts the correlations between and among components, and wherein the override is used as training input to the trained machine learning model.

Example 22 is a system for generating adaptable personalized calibration settings for a virtual reality experience application, comprising: means for presenting a user with a content related to a metric associated with virtual reality rendering or playback; means for receiving a rating for the content from the user, wherein the rating corresponds to a tolerance of the user; means for correlating the rating of the content and tolerance of the user with virtual reality characteristics including frame rate, judder, motion, blur, image resolution, brightness, contrast, wherein a correlation between and among components of the virtual reality experience is derived from a trained machine learning model; means for generating a personalized calibration setting for configuring the virtual reality experience application; and means for storing the personalized calibration setting in a tolerance profiles database accessible to a rendering engine of the virtual reality experience application.

In Example 23, the subject matter of Example 22 includes, means for repeating the presenting, the receiving and the correlating for at least one additional content.

In Example 24, the subject matter of Example 23 includes, means for dynamically re-calibrating the personalized calibration settings during runtime of the virtual reality experience, by a feedback engine, the feedback engine using at least one of explicit user feedback data, behavioral feedback data, emotional feedback data or environmental feedback data inferred from metrics received from a plurality of sensors.

In Example 25, the subject matter of Example 24 includes, wherein the plurality of sensors reside on at least one of a wearable device, a head mounted display, an object in the environmental, or a mobile device.

In Example 26, the subject matter of Examples 22-25 includes, means for automatically adjusting an importance ranking of an inference based on the user input, responsive to an indication that the user wants to override a calibration setting via user input, wherein the ranking of the inference adjusts the correlations between and among components, and wherein the override is used as training input to the trained machine learning model.

Example 27 is at least one machine-readable medium including instructions that, when executed by processing circuitry, cause the processing circuitry to perform operations to implement of any of Examples 1-26.

Example 28 is an apparatus comprising means to implement of any of Examples 1-26.

Example 29 is a system to implement of any of Examples 1-26.

Example 30 is a method to implement of any of Examples 1-26.

The techniques described herein are not limited to any particular hardware or software configuration; they may find applicability in any computing, consumer electronics, or processing environment. The techniques may be implemented in hardware, software, firmware or a combination, resulting in logic or circuitry which supports execution or performance of embodiments described herein.

For simulations, program code may represent hardware using a hardware description language or another functional description language which essentially provides a model of how designed hardware is expected to perform. Program code may be assembly or machine language, or data that may be compiled or interpreted. Furthermore, it is common in the art to speak of software, in one form or another as taking an action or causing a result. Such expressions are merely a shorthand way of stating execution of program code by a processing system which causes a processor to perform an action or produce a result.

Each program may be implemented in a high level procedural, declarative, or object-oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product, also described as a computer or machine accessible or readable medium that may include one or more machine accessible storage media having stored thereon instructions that may be used to program a processing system or other electronic device to perform the methods.

Program code, or instructions, may be stored in, for example, volatile or non-volatile memory, such as storage devices or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

Program code may be implemented in programs executing on programmable machines such as mobile or stationary computers, personal digital assistants, smart phones, mobile Internet devices, set top boxes, cellular telephones and pagers, consumer electronics devices (including DVD players, personal video recorders, personal video players, satellite receivers, stereo receivers, cable TV receivers), and other electronic devices, each including a processor, volatile or non-volatile memory readable by the processor, at least one input device or one or more output devices. Program code may be applied to the data entered using the input device to perform the described embodiments and to generate output information. The output information may be applied to one or more output devices. One of ordinary skill in the art may appreciate that embodiments of the disclosed subject matter may be practiced with various computer system configurations, including multiprocessor or multiple-core processor systems, minicomputers, mainframe computers, as well as pervasive or miniature computers or processors that may be embedded into virtually any device. Embodiments of the disclosed subject matter may also be practiced in distributed computing environments, cloud environments, peer-to-peer or networked microservices, where tasks or portions thereof may be performed by remote processing devices that are linked through a communications network.

A processor subsystem may be used to execute the instruction on the machine-readable or machine accessible media. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Although operations may be described as a sequential process, some of the operations may in fact be performed in parallel, concurrently, or in a distributed environment, and with program code stored locally or remotely for access by single or multi-processor machines. In addition, in some embodiments the order of operations may be rearranged without departing from the spirit of the disclosed subject matter. Program code may be used by or in conjunction with embedded controllers.

Examples, as described herein, may include, or may operate on, circuitry, logic or a number of components, modules, or mechanisms. Modules may be hardware, software, or firmware communicatively coupled to one or more processors in order to carry out the operations described herein. It will be understood that the modules or logic may be implemented in a hardware component or device, software or firmware running on one or more processors, or a combination. The modules may be distinct and independent components integrated by sharing or passing data, or the modules may be subcomponents of a single module, or be split among several modules. The components may be processes running on, or implemented on, a single compute node or distributed among a plurality of compute nodes running in parallel, concurrently, sequentially or a combination, as described more fully in conjunction with the flow diagrams in the figures. As such, modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured, arranged or adapted by using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

While this subject matter has been described with reference to illustrative embodiments, this description is not intended to be construed in a limiting or restrictive sense. For example, the above-described examples (or one or more aspects thereof) may be used in combination with others. Other embodiments may be used, such as will be understood by one of ordinary skill in the art upon reviewing the disclosure herein. The Abstract is to allow the reader to quickly discover the nature of the technical disclosure. However, the Abstract is submitted with the understanding that it will not be used to interpret or limit the scope or meaning of the claims.

What is claimed is:

1. A system for automatic and dynamic virtual reality session calibration, comprising:
a server compute node comprising a processor coupled to a memory, the processor to execute a virtual reality application according to a set of calibration parameters;
a feedback and aggregation engine coupled to the processor to:
receive a plurality of sensor metrics from at least one sensor, the sensor metrics associated with a user to provide aggregated metrics;
classify each of the aggregated metrics according to a set of characteristics;
generate a set of inferences regarding user tolerances corresponding to the classified metrics and rank each inference in the set of inferences based on the user tolerances; and
generate a set of calibration parameters personalized to the user, based on the ranked set of inferences; and
a predictive calibration engine to render the virtual reality content according to the personalized calibration settings for the user.

2. The system as recited in claim 1, wherein the personalized calibration settings are automatically and dynamically re-calibrated during runtime.

3. The system as recited in claim 1, further comprising:
a trusted execution environment coupled to the server compute node to securely communicate with the user.

4. The system as recited in claim 1, further comprising:
a user interface coupled to the server compute node to provide a cloud dashboard allowing the user to view the calibration parameters personalized to the user, and manually calibrate the calibration parameters for use by one or more devices.

5. The system as recited in claim 4, wherein the predicative calibration engine is further to:
infer an optimal calibration setting for a user application based on personalized calibration settings for a plurality of user calibration settings accessible by the cloud dashboard, wherein each of the personalized calibration settings is associated with a user, a device and a user application.

6. The system as recited in claim 1, further comprising a training calibration engine to:
provide test content to the user;
receive responses from the user regarding tolerance of the content;
generate an initial set of calibration settings for the user; and
store the initial set of calibration settings in a tolerance profile database accessible to the feedback and aggregation engine to implement dynamic re-calibration of the calibration settings during runtime responsive to the sensor metrics.

7. The system as recited in claim 1, wherein the sensors collect the sensor metrics associated with at least one of explicit user feedback data, behavioral feedback data, emotional feedback data or environmental feedback data.

8. The system as recited in claim 7, wherein the sensor metrics associated with the environmental feedback data are used to modify importance ranking of an inference.

9. The system as recited in claim 1, further comprising a user interface to enable the user to override a calibration setting with one of a physical or virtual control, and wherein responsive to a calibration setting being overridden by the user, the feedback and aggregation engine automatically adjusting an importance ranking of an inference based on the user input.

10. The system as recited in claim 1, wherein the calibration settings are related to at least one of visual, aural, movement, tactile, or haptic characteristics of the virtual reality application as presented to the user.

11. The system as recited in claim 10, wherein the virtual reality application provides a multi-user experience, and wherein calibration settings for a second user are automatically adjusted based on calibration settings of the first user to prevent unfair advantages based on superior device rendering or tolerance levels of the second user, and where the adjusted calibration settings are within a tolerance level for the second user.

12. A method for generating adaptable personalized calibration settings for a virtual reality experience application, comprising:
presenting a user with a content related to a metric associated with virtual reality rendering or playback;
receiving a rating for the content from the user, wherein the rating corresponds to a tolerance of the user;
correlating the rating of the content and tolerance of the user with virtual reality characteristics including frame rate, judder, motion, blur, image resolution, brightness, contrast,
wherein a correlation between and among components of the virtual reality experience is derived from a trained machine learning model;
generating a personalized calibration setting for configuring the virtual reality experience application; and
storing the personalized calibration setting in a tolerance profiles database accessible to a rendering engine of the virtual reality experience application.

13. The method as recited in claim 12, further comprising:
repeating the presenting, the receiving and the correlating for at least one additional content.

14. The method as recited in claim 13, further comprising:
dynamically re-calibrating the personalized calibration settings during runtime of the virtual reality experience, by a feedback engine, the feedback engine using at least one of explicit user feedback data, behavioral feedback data, emotional feedback data or environmental feedback data inferred from metrics received from a plurality of sensors.

15. The method as recited in claim 14, wherein the plurality of sensors reside on at least one of a wearable device, a head mounted display, an object in the environmental, or a mobile device.

16. The method as recited in claim 12, further comprising:
responsive to an indication that the user wants to override a calibration setting via user input, automatically adjusting an importance ranking of an inference based on the user input, wherein the ranking of the inference adjusts the correlations between and among components, and wherein the override is used as training input to the trained machine learning model.

17. At least one machine readable storage medium having instructions stored thereon, the instructions when executed on a machine cause the machine to:
present a user with a content related to a metric associated with virtual reality rendering or playback;
receive a rating for the content from the user, wherein the rating corresponds to a tolerance of the user;
correlate the rating of the content and tolerance of the user with virtual reality characteristics including frame rate, judder, motion, blur, image resolution, brightness, contrast,
wherein a correlation between and among components of the virtual reality experience is derived from a trained machine learning model;
generate a personalized calibration setting for configuring the virtual reality experience application; and
store the personalized calibration setting in a tolerance profiles database accessible to a rendering engine of the virtual reality experience application.

18. The medium as recited in claim 17, further comprising instructions to:
repeat the presenting, the receiving and the correlating for at least one additional content.

19. The medium as recited in claim 18, further comprising instructions to:
dynamically re-calibrate the personalized calibration settings during runtime of the virtual reality experience, by a feedback engine, the feedback engine using at least one of explicit user feedback data, behavioral feedback data, emotional feedback data or environmental feedback data inferred from metrics received from a plurality of sensors.

20. The medium as recited in claim 19, wherein the plurality of sensors reside on at least one of a wearable device, a head mounted display, an object in the environmental, or a mobile device.

21. The medium as recited in claim 17, further comprising instructions to:
responsive to an indication that the user wants to override a calibration setting via user input, automatically adjust an importance ranking of an inference based on the user input, wherein the ranking of the inference adjusts the correlations between and among components, and wherein the override is used as training input to the trained machine learning model.
